(19) United States
(12) Patent Application Publication
(10) Pub. No.: US 2003/0127198 A1
(43) Pub. Date: Jul. 10, 2003

(54) Unitary flexible roll-up door

(76) Inventors: Calvin L. Court, Texarkana, TX (US); Melvin T. Court, Texarkana, TX (US)

Correspondence Address: P. Weston Musselman, Jr., Esq., Jenkens & Gilchrist, P.C., 1445 Ross Avenue, Suite 3200, Dallas, TX, 75202-2799, US

(21) Appl. No.: 10/101,029

(22) Filed: Mar. 18, 2002

Related U.S. Application Data
(60) Provisional application No. 60/346,750, filed on Jan. 7, 2002.

(51) Int. Cl. E06B 3/48

(52) U.S. Cl. 160/231.1

(57) ABSTRACT

A roll-up door assembly for a variety of uses for example commercial vehicles, commercial buildings, residential buildings or other suitable purposes. The door assembly includes a flexible unitary panel constructed from a material comprising a fiber and resin composite. A plurality of transverse reinforcement members are affixed to the flexible panel. Rollers are rotably mounted on an axle and are adapted to be received in a track for guided movement of the flexible panel. The axle can be integral with the transverse reinforcement member or part of a roller bracket affixed to the transverse reinforcement member.

### BACKGROUND OF THE INVENTION

1. Technical Field of the Invention

The present invention relates generally to overhead or roll-up doors, and in particular to an overhead door made using composite materials.

2. Description of Related Art

An overhead or roll-up door is a type of door in which the door assembly is guided between an opened and closed position on a track affixed about the doorway. Overhead doors are generally constructed from materials like steel, aluminum or wood, and are in the form of multiple panels that are joined to one another and articulate about an axis transverse to the direction that the door moves. The articulation between individual panels is normally achieved either by hinges or by profiling the opposing side edges of the individual panels such that the profiled areas movably interlock with one another.

One overhead door structure is illustrated in U.S. Pat. No. 4,860,813 to Ballyns. The door has multiple panels joined together by hinges. A guide track is positioned at the edges of the door and rollers extending from the hinges are received by the guide track. A disadvantage of an overhead door of this type is that metal panels are prone to denting, scratching, marring or other similar damage. In addition, the articulation between individual panels can degrade with time, and may result in leakage from between seams of the individual panels. Dirt lodged between the individual panels exacerbates wear. Furthermore, if the individual panels are made of metal, the weight becomes relatively high and the metal sheet may rust or corrode over time. If made of wood, the panels are subject to warpage and water damage.

Therefore, there is a need for an overhead or roll-up door that eliminates the drawbacks associated with articulation between individual panels and problems associated with leakage, appearance, weight and corrosion of the prior overhead doors.

### SUMMARY OF THE INVENTION

The above problems are overcome in accordance with the present invention which relates to a roll-up door for a variety of uses for example commercial vehicles, commercial buildings, residential buildings or other suitable purposes. According to the teachings of the present invention, an embodiment of the present invention is directed to a door assembly for guided movement in a track of a roll-up door system positioned in a doorway. The roll-up door system comprises a flexible door panel including a unitary sheet sized to substantially cover the doorway, wherein the unitary sheet is constructed of a material comprising a fiber and resin composite. The system further comprises at least one transverse reinforcement member affixed to an exterior or an interior of the flexible door panel and adapted to engage the track for guided movement therein.

Another embodiment of the present invention is directed towards an insulated roll-up door system. The system comprises a flexible door panel including at least two unitary sheets held in spaced relation and each sized to substantially cover the doorway, wherein the at least two unitary sheets are constructed from a material comprising a fiber and resin composite. The system further comprises at least one transverse reinforcement member affixed to an exterior or interior of the flexible door panel and adapted to engage in the track for guided movement therein.

Another embodiment of the present invention is directed towards an insulated roll-up door system. The system comprises a flexible door panel including at least one unitary sheet sized to substantially cover the doorway, wherein the at least one unitary sheet is constructed from a material comprising a fiber and resin composite and includes insulation thereon. The system further comprises at least one transverse reinforcement member affixed to an exterior or interior of the flexible door panel and adapted to engage in the track for guided movement therein.

An advantage of the invention is that the unitary flexible panel eliminates any leakage from individual panels of the doors and makes the door water resistant.

Another advantage of the invention is that unitary flexible panel made of fiber and resin composite is corrosion resistant and has substantially less weight as compared to metal or wood doors.

Another advantage of the present invention is that the flexible unitary panel eliminates dirt being lodged between individual panels of doors.

Another advantage of the present invention is that the flexible unitary panel made of fiber and resin composite is less prone to denting, scratching, marring or other similar damage.

Another advantage of the present invention is that the flexible unitary panel made of fiber and resin composite eliminates warping, rotting or other similar damage.

Additional advantages of this invention will become apparent from the following drawings and description of the preferred embodiments.

### BRIEF DESCRIPTION OF THE DRAWINGS

Various objects and advantages of the invention will become apparent and more readily appreciated from the following description of the presently preferred exemplary embodiments, taken in conjunction with the accompanying drawings of which:

FIG. 1 is a simplified perspective view of a van equipped with an overhead or roll-up door system made in accordance with this invention;

FIG. 2 is an interior view of the roll-up door in accordance with the present invention;

FIG. 3 is a view of a stiffener bar as used in the present invention;

FIGS. 4(a), 4(b), and 4(c) are perspective views of exemplary roller brackets in accordance with the present invention;

FIG. 4(d) is an enlarged view of an integrated removable roller bracket according to the present invention;

FIG. 5 is a cross-sectional view illustrating an insulated door construction according to the present invention;

FIG. 6 is a cross-sectional view illustrating another insulated door construction according to the present invention;

FIG. 7 is a cross-sectional view illustrating another insulated door construction comprising a single flexible panel according to the present invention;

FIGS. 8(a) and 8(b) are cross-sectional views illustrating another insulated door construction according to the present invention; and

FIG. 9 is an enlarged view of a roller integrated into the stiffener bar.

### DETAILED DESCRIPTION OF THE EXEMPLARY EMBODIMENTS OF THE INVENTION

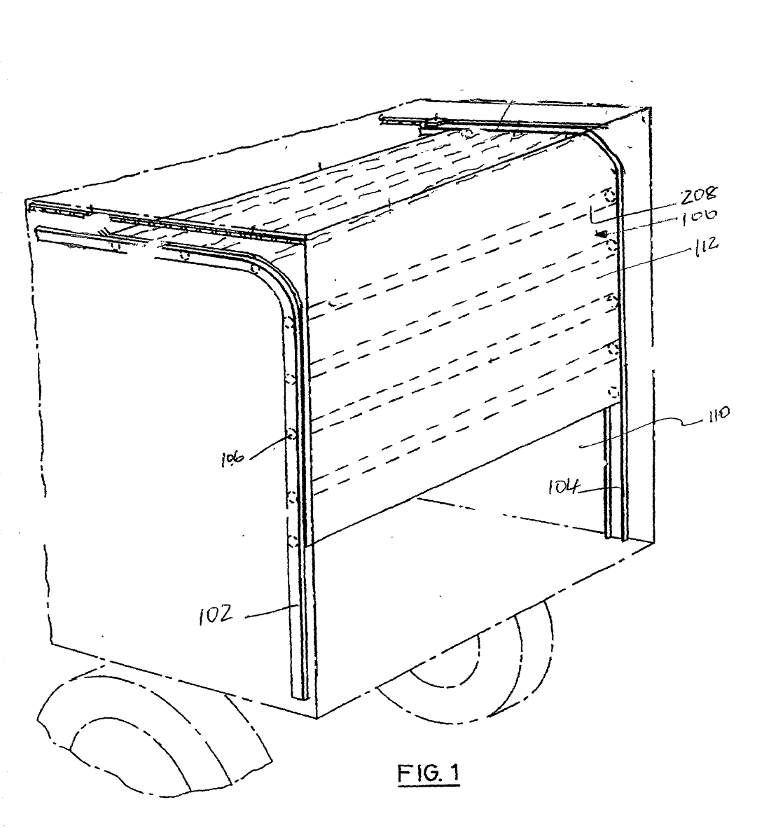

With reference to FIG. 1 of the drawings, an overhead or roll-up door assembly 100 constructed in accordance with the invention is shown installed in a doorway or opening 110 of a van body. The door assembly 100 includes a unitary, substantially planar, flexible panel 112 having a plurality of rollers 106 distributed in spaced relation on opposite sides of the flexible panel 112. Guide frames 102 and 104 extend vertically, in opposed relation, along the sides of opening 110 and curve to horizontal. Rollers 106 are received in opposed guide frames 102 and 104 to guide the door assembly 100 through a range of motion, including a closed position in which a substantial portion of the door assembly 100 is vertical and covers the opening 110 and an open position in which a substantial portion of the door assembly 100 is horizontal leaving opening 110 substantially unobstructed. FIG. 1 depicts the door assembly 100 positioned part way between the opened and closed positions to illustrate the curvature that the flexible panel 112 must achieve when moved between the opened and closed positions. The guide frames 102 and 104 can have a C-shaped profile that retainingly receives the rollers 106.

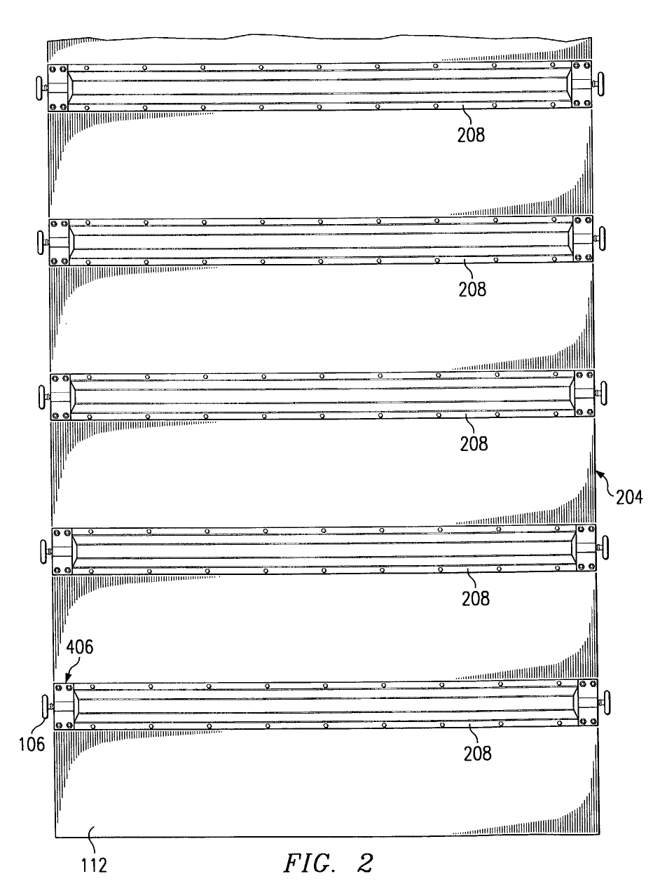

Referring to FIG. 2 of the drawings, an interior view of the door and its construction will be described in detail. The panel 112 can be constructed from a unitary sheet of material comprising a fiber and resin composite. The flexible panel 112 is sized to substantially cover the opening 110 (FIG. 1). The fiber can include virtually any fibrous material, for example but in no means by limitation, fiber glass, aramid fiber (e.g. KEVLAR, a registered trademark of I.E. du Pont de Nemours and Company), carbon fiber, and combinations thereof. The fibers can be of a type that have very little elasticity when loaded in tension and can be woven in a pattern similar to fabric or can be matted. The resin can be virtually any polymer resin that can bind the fibers to form a sheet. Further, the fiber and resin composite can be a single layer of fibers bonded by resin or multiple layered, and include additional materials, for example polymer films. Two examples of fiber and resin composites suitable for use in the flexible panel 112 of the invention include ARMORTUF (a registered trademark of Kemlite Company, Inc.) and BULITEX (a registered trademark of LLC DBA U.S. Liner Company). Also, flexible panel 112 can be constructed from polymer sheet material that may be reinforced by a fiber and resin composite. In any case, the flexible panel 112 as used herein is such that it will not substantially stretch in the plane of the panel, but can be flexed in a direction perpendicular to the plane of the panel without substantial plastic deformation or breakage and then recover or flex back to its original planar shape.

A plurality of stiffener bars 208 are affixed transversely across the width of the flexible panle 112, either continuously or partially. The plurality of stiffener bars 208 can be fixed on the exterior or interior of the flexible panel 112 for reinforcement. In the vertical position shown, the stiffener bars 208 are horizontally arranged substantially parallel to each other. When mounted on the flexible panel 112, the stiffener bars 208 provide rigidity in a direction perpendicular to the plane of the panel 112 and support the rollers 106. An exemplary stiffener bar 208 is depicted in FIG. 3 having a deep channel section 302 with flange portions 304 adjacent the channel section 302. Other stiffener bar 208 shapes can be used with the door of this invention. The stiffener bars 208 may be made of virtually any material for example wood, plastic, steel, aluminum, composites, polymers, or combinations thereof, or other suitable material and connected to the flexible panel 112 by adhesives, mechanical fasteners or other convenient means.

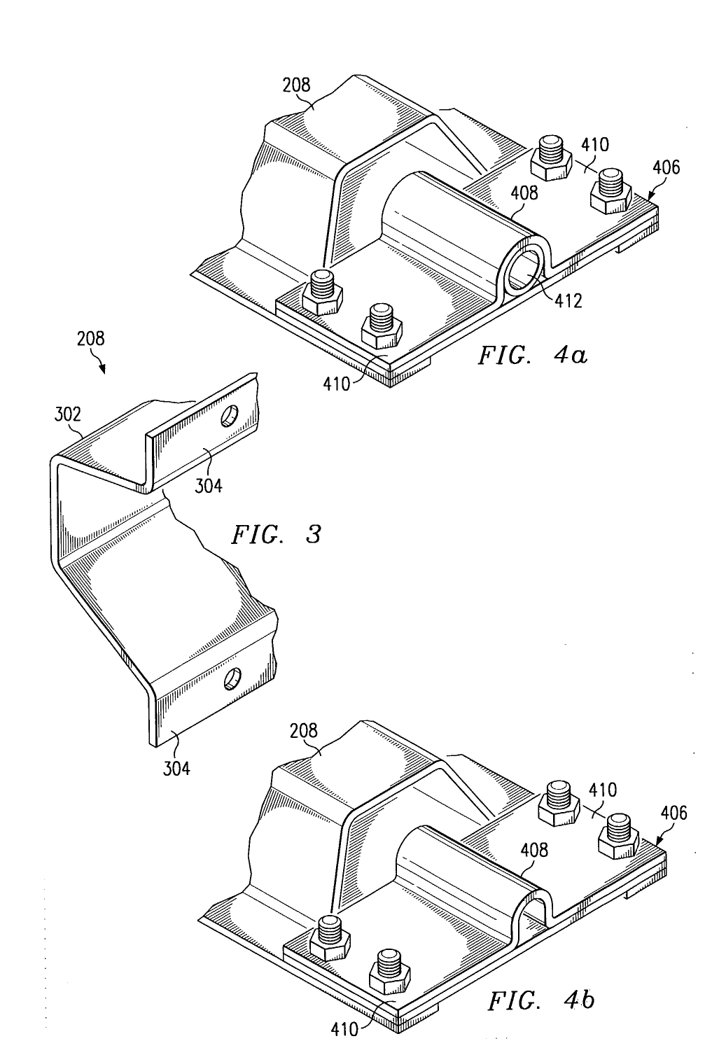

FIGS. 4(a), 4(b), and 4(c) depict exemplary roller brackets 406 which can be connected at opposing ends of the stiffener bars 208 or at ends of partial bars. Referring first to FIG. 4(a), one exemplary roller bracket 406 has a circular channel section 408 with substantially planar flange portions 410 adjacent the circular channel section 408. The channel section 408 and flange portions 410 can be formed from a single piece of material, for example a piece of plate bent to include the channel section 408 and flange portions 410 as seen in FIG. 4(a). The flange portions 410 of the roller bracket 406 abut and are affixed to the flange portions 304 (FIG. 3) of the stiffener bars 208 by welding, adhesives, or mechanical fasteners such as screws, bolts, rivets or other convenient means. The roller bracket 406 of FIG. 4(a) further comprises a cylindrical bushing 412 held closely within the circular channel section 408. The cylindrical bushing 412 receives a roller axle 402 (FIG. 4(d)) on which a roller 106 is rotatably mounted. Alternatively, referring to FIG. 4(b) the roller bracket 406 can be configured to receive the roller axle 402 directly within the circular channel section 408 and does not incorporate the cylindrical bushing 412 as described earlier with reference to FIG. 4(a). In another exemplary embodiment, the cylindrical bushing 412 can be affixed directly onto the flange portions 410 as shown in FIG. 4(c) for example by welding, adhesives or other convenient method. FIG. 4(d) provides an enlarged illustration of a roller bracket 406 assembled with a roller 106 and roller axle 402. The roller bracket 406 including the cylindrical bushing 412 may be formed of steel, but a variety of materials such as other metals, composites, polymers, or combinations thereof may be used.

As seen in FIG. 9, the roller axle 904 can be an integral part of the stiffener bar 902, in which case the roller bracket 406 need not be included. The roller 106 is then rotatably mounted to the roller axle 904 of stiffener bar 902 that is mounted to panel 906.

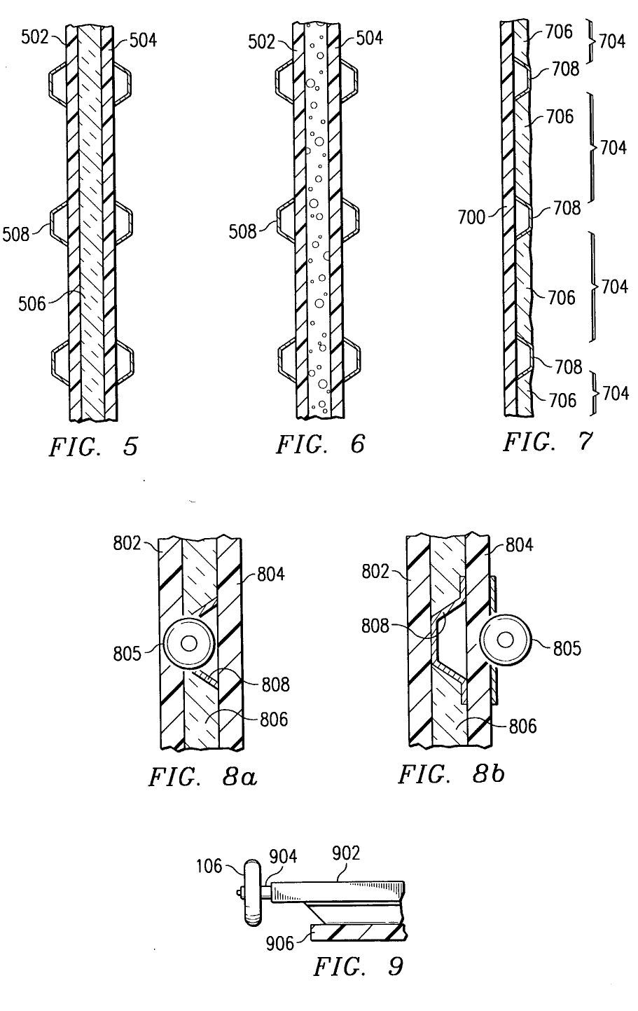

Referring to FIG. 5 of the drawings, in an alternate embodiment of the present invention the unitary flexible panel 500 comprises a substantially parallel inner sheet 502 and outer sheet 504, each of which are constructed of fiber and resin composites similar to those described above. The construction of the flexible panel 500 is similar to that described earlier with reference to the stiffener bars 208, rollers 106 and roller bracket 406 in FIGS. 2 and 4. Also, the roller can be integrated with the stiffener bars 508 as discussed above. Stiffener bars 508 can be positioned on an exterior surface of the panel 500. The open space between the flexible sheets 502 and 504 is filled with a flexible insulating material 506. In an exemplary embodiment, a flexible foam material is layered into place between the flexible sheets 502 and 504. Virtually, any flexible material is suitable provided that it has good insulating properties and is capable of holding the sheets 502 and 504 in a spaced-apart relation.

Referring to FIG. 6, a gas or air can be used as the insulating material by providing a “dead air” space between the flexible sheets 502 and 504. The construction of the flexible sheets 502 and 504 with respect to the stiffener bars 508 used for transverse reinforcement are substantially the same as that shown in FIGS. 2 and 4.

Referring to FIG. 7 of the drawings, an insulated door using a single unitary flexible panel 700 can be provided. The construction of the flexible panel 700 is similar to that described earlier with reference to the stiffener bars 208, rollers 106 and roller bracket 406 in FIGS. 2 and 4. The stiffener bars 708 may be placed on either the interior or exterior of the flexible panel 700. The space 704 between the stiffener bars 708 is filled with insulating material 706. In an exemplary embodiment, a flexible foam material may be used for insulating. Virtually, any flexible material is suitable provided that it has good insulating properties and adheres to the space 704 between the stiffener bars.

FIGS. 8(a) and 8(b) depict a panel 800 similar to that of FIG. 5, but incorporating the stiffener bars 808 inside the panel 800. The unitary flexible panel 800 comprises a substantially parallel inner sheet 802 and outer sheet 804, each of which are constructed of fiber and resin composites similar to those described above. The construction of the flexible panel 800 is similar to that described earlier with reference to the stiffener bars 208, rollers 106 and roller bracket 406 in FIGS. 2 and 4. However, in the present embodiment, the stiffener bars 808 are placed in between the inner sheet 802 and the outer sheet 804. In an exemplary embodiment (FIG. 8(a)), the roller bracket 805 may be connected to the stiffener bars 808 between the inner sheet 802 and the outer sheet 804. Alternately, the roller bracket 805 can be affixed through the exterior of the panel 800 to the stiffener bars 808 (FIG. 8(b)). Also, the roller can be integrated with the stiffener bars 808 as discussed above. The open space between the flexible sheets 802 and 804 and the stiffener bars 808 is filled with a flexible insulating material 806. In an exemplary embodiment, a flexible foam material is layered into place between the flexible sheets 802 and 804. Virtually, any flexible material is suitable provided that it has good insulating properties. Also, the insulating material can be air or gas as stated above.

Due to the use of fiber and resin composite, the weight of the door of the present invention is considerably reduced in comparison to the multiple articulated panels used in prior doors. Since the flexible panel of the present invention comprises a unitary panel, this eliminates any leakage from seams or individual panels. Also, the fiber composite flexible panel 112 is water resistant and not subject to warping like a wooden articulated multiple panel door. Furthermore, the fiber and resin composite used to construct the flexible panels of the present invention is rust proof.

Fiber composites have a lower rate of heat transfer, thus the flexible panel will not transmit heat through the opening or become hot to the touch as readily as a metallic door. The fiber composites used to construct the flexible panel can be chemical resistant. Unlike prior art designs that have incorporated the support structure into the door, mounting the support bars on the exterior or the interior of the flexible panel allows the two components to be fabricated separately. Thus, pre-fabricated flexible panels and support bars can be used to reduce manufacturing costs. Finally, the door assembly can be configured to retrofit to existing systems.

The flexible panel can be constructed of fiber composite that is translucent to transmit light into the opening, for example, by use of a translucent fiber and/or translucent resin. Coloration can be introduced to the resin to produce colored flexible panels, either translucent or opaque. Also, different colored fibers can be used to introduce coloration. The flexible panel can be surface coated, for example with paint or gelcoat. Since fiber composites are less prone to denting, scratching, marring or other similar damage, the flexible panel will remain aesthetically attractive over time. If the color is introduced to the resin or fibers, the coloration will not scratch or wear off the flexible panel.

It is understood that variations may be made in the foregoing without departing from the scope of the invention. Although embodiments of the invention have been illustrated in the accompanying Drawings and described in the foregoing Detailed Description, it will be understood that the invention is not limited to those embodiments disclosed, but is capable of numerous rearrangements, modifications and substitutions as may be included in the spirit and scope of the invention as defined in the following claims.

We claim:

1. A door assembly for guided movement in a track of a roll-up door system, the roll-up door system positioned in a doorway, comprising:
a flexible door panel including at least one unitary sheet sized to substantially cover the doorway, wherein the at least one unitary sheet is constructed of a material comprising a fiber and resin composite; and
at least two transverse reinforcement members affixed to a surface of the flexible door panel and adapted to engage the track for guided movement therein.

2. The door assembly according to claim 1, wherein said flexible unitary panel is made of fiberglass.

3. The door assembly according to claim 1, wherein said flexible unitary panel is translucent.

4. The door assembly according to claim 1, wherein said flexible unitary panel is opaque.

5. The door assembly according to claim 1, wherein said flexible unitary panel is rust proof.

6. The door assembly according to claim 1, wherein said flexible unitary panel is water resistant.

7. A roll-up door system positioned in a doorway for guided movement comprising:
a track assembly;
a flexible panel including a unitary sheet sized to substantially cover the doorway, wherein the unitary sheet is constructed of a material comprising a fiber and resin composite; and
at least two transverse reinforcement members affixed to the flexible panel door panel and adapted engage the track for guided movement therein.

8. The system of claim 6, wherein said flexible panel comprises fiberglass.

9. The system of claim 6, wherein said flexible panel is translucent.

10. The system of claim 6, wherein said flexible panel is opaque.

11. The system of claim 6, wherein said flexible panel is rust proof.

12. The door assembly according to claim 6, wherein said flexible unitary panel is water resistant.

13. An insulated door assembly for guided movement in a track of a roll-up door system, the roll-up door system positioned in a doorway, comprising:
a flexible door panel including at least two unitary sheets held in spaced relation and each sized to substantially cover the doorway, wherein the at least two unitary sheets are constructed from a material comprising a fiber and resin composite and includes insulation therebetween; and
at least two transverse reinforcement members affixed to a surface of the flexible door panel and adapted to engage the track for guided movement therein.

14. The door assembly according to claim 11, wherein at least one of said at least two unitary sheets is made of fiberglass.

15. The door assembly according to claim 11, wherein said flexible panels are translucent.

16. The door assembly according to claim 11, whrein said flexible panels are opaque.

17. The door assembly according to claim 11, wherein said unitary sheets are rust proof.

18. The door assembly according to claim 11, wherein the insulation is a foam material between said at least two unitary sheets.

19. The door assembly according to claim 11, wherein said insulating material is air.

20. The door assembly according to claim 11, wherein said flexible unitary panels are water resistant.

21. An insulated door assembly for guided movement in a track of a roll-up door system, the roll-up door system positioned in a doorway, comprising:
a flexible door panel including at least one unitary sheet sized to substantially cover the doorway, wherein at least one unitary sheet is constructed from a material comprising of a fiber and resin composite and includes insulation thereon; and
at least two transverse reinforcement members affixed to a surface of the flexible door panel and adapted to engage the track for guided movement therein.

22. The door assembly according to claim 18, wherein at least one unitary sheet is made of fiberglass.

23. The door assembly according to claim 18, wherein said flexible door panel is translucent.

24. The door assembly according to claim 18, wherein said flexible door panel is opaque.

25. The door assembly according to claim 18, wherein said unitary sheet is rust proof.

26. The door assembly according to claim 18, wherein said flexible unitary panel is water resistant.

27. A door assembly for guided movement in a track of a roll-up door system, the roll-up door system positioned in a doorway, comprising:
a flexible door panel sized to substantially cover the doorway and having at least two transverse reinforcement members;
an axle extending outwardly from at least one end of each of the at least two transverse reinforcement members; and
a roller rotatably mounted on the axle, the roller configured for guided movement in the track.

28. The door assembly according to claim 23, wherein said flexible unitary panel is made of fiberglass.

29. The door assembly according to claim 23, wherein said flexible unitary panel is translucent.

30. The door assembly accoring to clam 23, wherein said flexible unitary panel is opaque.

31. The door assembly according to claim 23, wherein said axle is integrated with said transverse reinforcement member.

32. The door assembly according to claim 23, further comprising at least one roller bracket affixed to at least one end of at least one of said transverse reinforcement members, wherein the roller bracket has a substantially planar flange portion that abuts the transverse reinforcement member and a cylindrical channel portion that receives the axle.

33. The door assembly according to claim 27 wherein the roller bracket is formed from a single piece of material.

34. The door assembly according to claim 27 wherein the cylindrical channel closely receives a cylindrical bushing, and wherein the cylindrical bushing receives the axle.

35. The door assembly according to claim 23 further comprising at least one roller bracket affixed to at least one end of at least one of said transverse reinforcement members, wherein the roller bracket has a substantially planar flange portion that abuts the transverse reinforcement member and a cylindrical bushing affixed to the flange portion, and wherein the cylindrical bushing receives the axle.
